(19) United States
(12) Patent Application Publication
(10) Pub. No.: US 2021/0125272 A1
(43) Pub. Date: Apr. 29, 2021

(54) Using Inferred Attributes as an Insight into Banking Customer Behavior

(71) Applicant: Bottomline Technologies (de) Inc., Portsmouth, NH (US)

(72) Inventor: Anirban Sinharoy, Mumbai (IN)

(73) Assignee: Bottomline Technologies (de) Inc., Portsmouth, NH (US)

(21) Appl. No.: 16/723,048

(22) Filed: Dec. 20, 2019

(30) Foreign Application Priority Data
Oct. 24, 2019 (IN) 201941043291

(51) Int. Cl. G06Q 40/02; G06Q 30/00; G06Q 10/04

(52) U.S. Cl. CPC G06Q 40/02; G06Q 10/04; G06Q 30/01

(57) ABSTRACT

A system and method for using inferred attributes derived from banking data is described. The system and method include a flexible configuration system that permits numerous insights to be created, said insights used to monitor and predict the behavior of banking customers. The insights allow thresholds to be monitored over a period of time, and the combination of thresholds and trends of implied attributes to create complex insights. This allows bankers to detect anomalies in customer behavior.

### PRIOR APPLICATION

This is a priority application.

### BACKGROUND

### Technical Field

The present disclosure relates generally to behavior prediction and more particularly to the use of software inferred attributes to predict banking customer behavior.

### Description of the Related Art

Banking is similar to other businesses, in that there is competition over customers, and each bank needs to evaluate the number of new customers and the retention rates of existing customers. Many banks spend millions in advertising to obtain new customers, and often visit companies in an attempt to sell their banking services to new customers. There are many sales techniques available for bankers.

Knowledgeable, timely outreach by bankers to consumer, business and wealth customers with intelligent insights, financial recommendations and events enables financial institutions to acquire, deepen, and grow profitable relationships. Customers expect bankers to understand their relationship with the bank and want their primary banker to proactively offer relevant insights and solutions for their business. Banks that deliver intelligent, insightful experiences can expect customers to reward them with significantly higher intent to purchase additional products and services. Business owners are much more likely to refer another company to a bank that delivers timely, intelligent recommendations. Bankers that understand their customers' businesses and provide tailored solutions lead far more often to exclusive primary bank relationships.

Customer expectations are increasing. Megabanks and non-bank Fintech providers are making investments in smart digital solutions to enhance customer experiences. Community and regional banks and credit unions struggle with creating a single view of the customer and with identifying key customer milestones and events that signal opportunities to deepen relationships and cross-sell. Voice of the customer research illustrates the positive impact that proactive, intelligent and relevant outreach has on customer loyalty, subsequent purchase decisions and the likelihood of customers to refer other business to the bank. It is more important than ever to quickly deploy a cost-effective, low-risk solution to meet the growing competition for your customer's wallet.

There is a strong need in the banking community for deep analysis of customer behavior in order to understand the needs of the customer, so that the proper products can be recommended and that customer expectations are met.

Typically, bankers have been surprised when a major customer leaves the bank for a competitor. There are no effective tools to help identify customers who are at risk for leaving. If the bank is fortunate, the customer will complain about services or rates, providing insight into the unhappiness of the customer. But customer service metrics show that only about 10% of unhappy customers complain. Another possible solution is to poll customers about their sentiments, but a large number of polls asked of users means that few customers will rely.

Instead, banks are surprised when customers leave. Is there a better way to predict defections from banking customers? Banks have a substantial amount of data on their customers, from detailed financials required for loan applications to a transaction-by-transaction database of the payments and receipts of the customer. The bank has a good understanding of the customer's wealth and could determine the customer's income statement in many cases. With all of this data, there must be insight into the customer's relationship with the bank.

In a sense, the issue is the sheer volume of data. The data needs to be filtered, analyzed, and compiled into meaningful insights into the customer's behavior and financial condition. Does the customer have a large balance at the end of the day? Perhaps the banker should sell the customer on a sweep account to earn extra interest on the unused cash. Have the number of transactions dropped off significantly? Perhaps the customer is beta testing a new bank. Has the account balance been trending downwards? Perhaps the customer needs a loan or business advice before the account runs out of funds.

The present inventions resolves the issues around data availability. Previous work in the field has focused on simply looking at the balance of an account, without the complex analysis needed to determine what is happening to each customer. Other previous work involved manual scanning of business reports across the entire customer base often assisted with drill down capability on the reports. It has always required a human to interpret the data. The required special skills at interpretation of data and hence the reports were out of reach to most bankers. Reporting on anomalies and insightful observations with previous methods occurred after a few days of actual occurrence of an event, resulting in untimely reports. The present inventions resolves this issue.

### SUMMARY OF THE INVENTIONS

A method for creating insights about banking customer behavior is described herein. The method is made up of the steps of (1) configuring the insight configuration about the banking customer, (2) ingesting data related to financial transactions and dimensional data, as specified by the insight configuration, (3) creating inferred attributes through automated statistical analysis of the data, (4) filtering the inferred attributes to a subset of attributes needed to perform the insights according to the insight configuration, (5) performing an insight analysis on the subset of attributes as specified by the insight configuration, over a period of time, and (6) reporting the insights as found by the insight analysis.

The dimensional data in the method could be retrieved from a combination of social media, a bank's core banking system, and a customer relationship management system. In some cases, the performance of the insight analysis returns a numerical score, and this score could be weighted. It could also be from a calculation of a plurality of numerical scores. The insight analysis could include a trend over time, and the trend could be a surplus balance. The insight analysis could return a Boolean result, and the Boolean result could be derived from a plurality of conditions.

A system for creating insights about banking customer behavior is also described herein. The system is made up of an internet, and a special purpose data management server, in communication with a special purpose insights server, wherein the special purpose data management server ingests data related to financial transactions and dimensional data, as specified by an insight configuration, creates inferred attributes through automated statistical analysis of the data, and filters the inferred attributes to a subset of attributes needed to perform the insights according to the insight configuration. The system also includes a blob storage device connected to the special purpose data management server, the blob storage device storing the financial transactions and the dimensional data. Furthermore, the system includes a SQL storage device connected to the special purpose data management server, the SQL storage device storing at least a portion of the configuration data. And the system includes the special purpose insights server in communication to the internet, wherein the special purpose insights server performs an insight analysis on the subset of data received from a special purpose data management server, as specified by the insight configuration, over a period of time, and reporting the insights as found by the insight analysis to a computing device, and the computing device in communication to the special purpose insights server via the internet.

### BRIEF DESCRIPTION OF THE DRAWINGS

The annexed drawings, which are not necessarily to scale, show various aspects of the inventions in which similar reference numerals are used to indicate the same or similar parts in the various views.

FIG. 1 is a high level design model showing the relationship of the features, data, insights, and scoring in the configuration of the system.

FIG. 2 is a detailed design model of the feature configuration and feature metrics.

FIG. 3 is a detailed design model of the configuration of the feature filters.

FIG. 4 is a detailed design model of the scoring and insight configuration.

FIG. 5 is an operational relationship chart for one possible embodiment.

FIG. 6 shows a possible hardware implementation for the algorithms included herein.

FIG. 7 is a detailed design model of the trending configuration.

### DETAILED DESCRIPTION

The present disclosure is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

The present disclosure provides several embodiments for providing insights into banking customer behavior using inferred attributes. This system is flexible in nature, allowing the bankers to create custom insights to watch over the behavior of banking customers. These custom insights are monitored by the system, and the banker is alerted when an insight is triggered. As part of the flexibility, the systems makes extensive use of inferred attributes, where banking data is massaged and combined to create derivative attributes. For instance, the balances of several accounts could be monitored for month long trends to determine the inferred attribute of a surplus balance (the balance that the sum of the accounts never goes below). This surplus balance indicates an opportunity to move the surplus balance into a higher interest account.

Other inferred attributes could be trending towards an insufficient balance event, or monitoring activity over several commercial account to determine if the customer is considering a move to another bank.

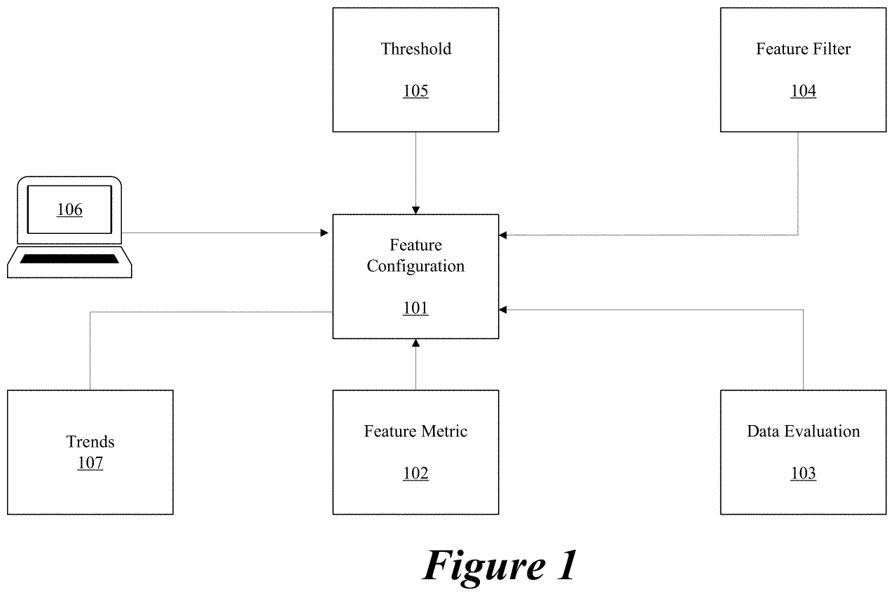

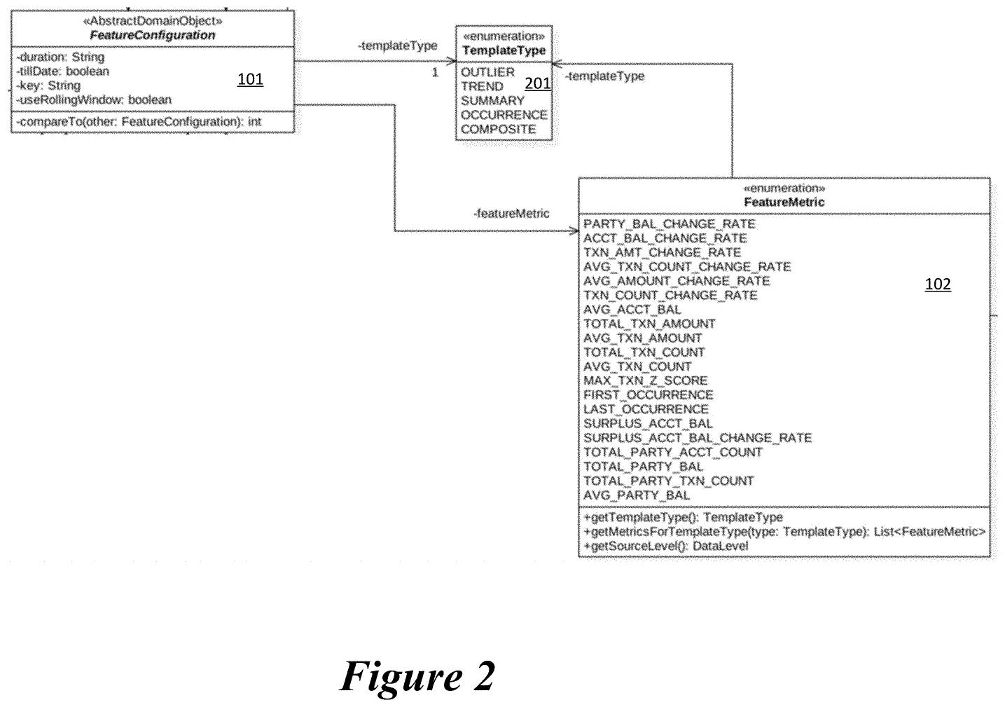

Looking to FIG. 1, the overall architecture of the configuration of the system is seen. FIG. 1 should be viewed in conjunction with FIGS. 2, 3, 4, and 7. These figures have been separated to enhance readability. FIG. 1 shows the general interconnections of the major configuration modules.

A banker using a personal computer, a laptop, a tablet, a smart phone, a smart watch, a note book, a surface, or any other computing or computer input device 106 uses the feature configuration 101 function to set up the metrics to identify the characteristics of interest and the ways to monitor the characteristics. The computing device 106 could be the personal computer 601 or laptop 602.

The feature configuration 101 is the central core of a number of aspects that need to be set up and the starting point for the discussion here. The feature configuration 101 is an abstract domain object. The feature configuration 101 takes a period, or duration, parameter that specifies the granularity of the date, whether daily, weekly, or monthly. It also takes a parameter on the end date of the configuration, and a key string that allows for other parameters to be monitored. The feature configuration creates a configuration to observe a specific aspect of a customer's behavior.

The feature configuration 101 object also contains a compareTo function that compares the configuration being created with a previous configuration. The purpose is to optimize the data processing by avoiding duplicate efforts for similar configuration.

A number of other classes of configuration parameters have a relationship with the feature configuration 101. The feature metric 102 which defines the statistics view of the type of inferred metric, are defined and have an aspect of the configuration 101.

In addition, the data level 103 has a relationship with the configuration 101. This data level define whether the data is sourced at a transaction level, an account level, or at a customer level.

The feature filter 104 defines the filters that are applied to the data and metrics. This portion of the configuration 101 eliminates data or types of data based on a criteria.

The threshold 105 functions prevents information overload by limiting the alerts to certain data aspects, eliminating the cases if the data is below of above various thresholds. The threshold 105 also has a relationship with the configuration 101.

The trending 107 functions allow configuration 101 of the trends in the data, and allow the use of trends in the insights.

FIG. 2 shows the relationship of the feature configuration 101 with the feature metric 102. The feature metric 102 provides for the configuration of the various bank account and customer metrics, such as the customer balance change rate, the account balance change rate, the transaction amount change rate, the average number of transactions change rate, average account balance, total transaction amount, average transaction amount, total transaction count, average in statistics of a value's relationship to the mean of a group of values, measured in terms of standard deviations from the mean), a first or last occurrence of an event, a surplus account balance (a surplus balance is the account balance plus the typical deposits minus the typical payment amounts during a period), a surplus balance change rate, total customer account count, total customer balance across all accounts, total customer transaction count, or the customers average balance across all accounts. These are the inferred attributes that are computed daily and appended to the regular descriptor attributes for the customer or account entity.

The feature metric 102 has at least three functions that are available. The getTemplateType returns the template type, as set in the template type 201 object. The template type could be an outlier, identifying a feature metric that is outside of the normal range. The template type could also be a trend of the feature metric, or a summary, or a specific occurrence. Furthermore it could be a composite of several template types or feature metrics.

Another feature metric 102 function is the getMetricsForTemplateType that returns the acceptable features metric for a specific template. A getSourceLevel function returns the data level, transaction, account or customer, for a specific template.

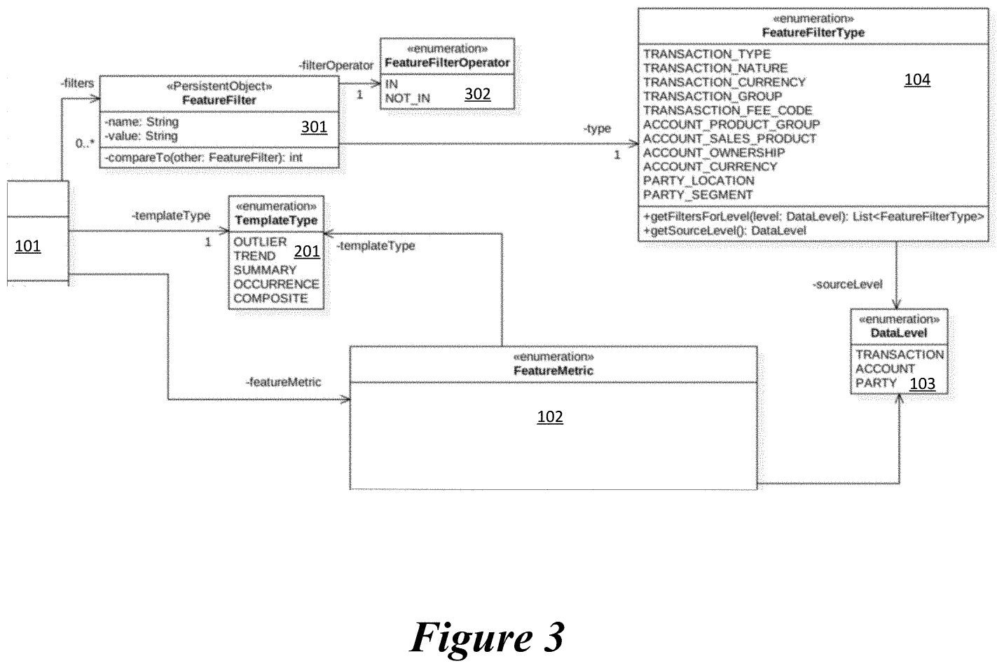

Looking to FIG. 3, the data level 103 is defined as transaction, account or customer levels. This indicates the source of data for the computing the feature. In addition, the feature filter 301 is defined as a combination of two strings, one enumerating the feature filter operator 302 as either in or not in (i.e. inclusive or exclusive). The second string enumerates the feature filter type 104. There could be zero, one, or more feature filter 301 instances. The filter is applied on the dataset as per the data level. The feature filter 104 could be a transaction type, a transaction nature, a transaction currency, a transaction group, or a transaction fee code. Other feature filters 104 could be customer location or customer segment. Further feature filters 104 could include account product group, an account sales product, account ownership, or account currency. The feature filter could include functions to getFiltersForLevel that returns the list of applicable features given a data level, and a getSourceLevel that returns the data level. In addition, a compare function is provided to compare feature filters.

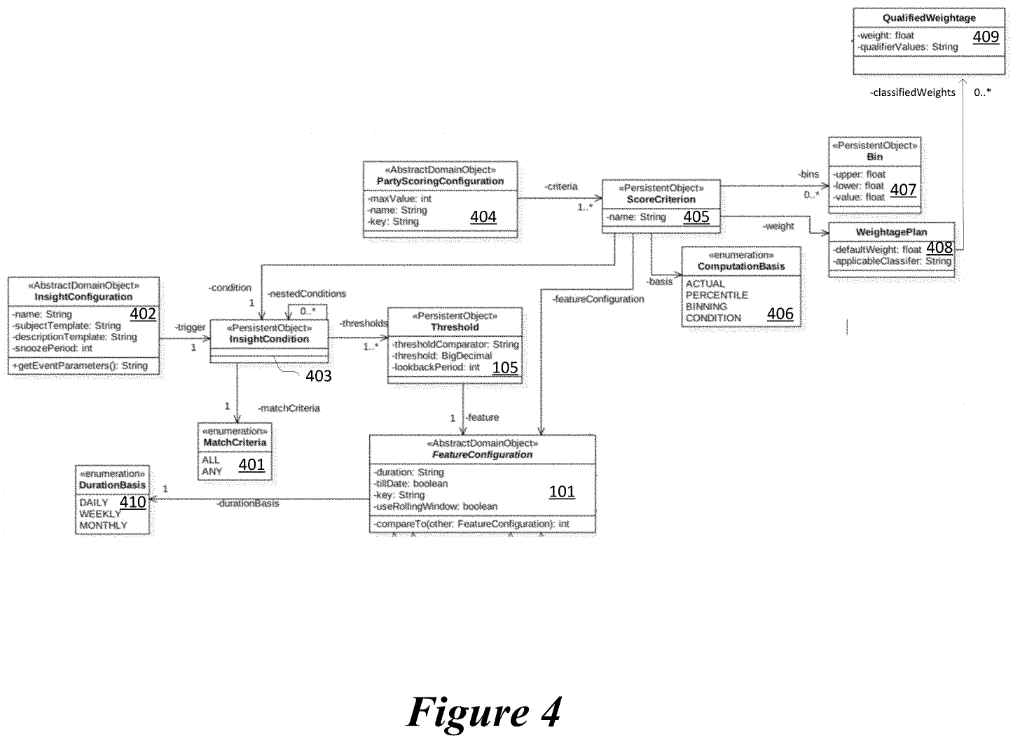

In FIG. 4, the thresholds are set 105. This is a configuration object, with a thresholdComparator (like Greater_Than, Less_Than, Equal_to, Greater_Than_Or_Equal_To, Less_Than_Or_Equal_To), a threshold number to compare against, and a lookback period. The system supports one or more threshold 105 objects.

The thresholds are built into an insight condition 403, which is also a configuration object. The insight condition evaluates the threshold breach into a Boolean value True or False for compound conditions. For compound conditions, there could be zero, one or more nested conditions. The insight condition 403 has a match criteria 401 whereby either all or any of the conditions must be matched. Typically, the insight condition returns a Boolean result.

The insight condition 403 is configured with the insight configuration 402. This object has a name, a subject template, a description template and a snooze period which indicates the gap between two such occurrences of the same insight for a customer or account. The insight is raised for customer or account using the subject and description. This object supports a getEventParameter function.

The score criterion 405 uses either the insight condition 403 or feature configurations via the feature configuration object 101. There are one or more score criterion 405 objects in a scoring configuration. The party scoring configuration 404 is configured using one or more score criterion 405. The party scoring configuration 404 takes the maximum value (i.e. max possible score, the name, and a key as parameters. The computational basis 406 enumeration also feeds into the score criterion 405, the computation basis 406 taking either the actual, a percentile, a binning, or a condition. If the basis is a condition, the criterion should use the insight condition 403 to evaluate the value 0 or 1. If the basis is percentile, the value obtained at each customer or account level as per the feature configuration 101 will be converted into percentile value. If the basis is actual, the value obtained at each customer or account level as per the feature configuration 101 will be used as-is. If the basis is binning, the value obtained at each customer or account level as per the feature configuration 101 will be binned as per bin definition. The score criterion 405 object takes zero or more definitions of bins in the bin 407 object. The bins take an upper level of the bin range, a lower level of the bin range and a value. The value obtained at each customer or account level as per the feature configuration 101 is compared between the upper and lower value of the bin, and if it matches, then the bin value used as criterion output.

Importance boosting is supported in the score criterion 405 through the weightage plan 408 object. This object has a default weight and an applicable classifier parameters. The classifier parameter determines which customer classification plan should be used to provide alternative weightage. The plan receives zero or more qualified weightages 409 instances. The qualified weights 409 instance assigns an alternate weight based on the qualifier value parameter (ie matches one of the values assigned to the customer as per the classification plan).

The duration of the feature configuration 101 could be a duration basis 410, perhaps daily, weekly, or monthly. It is used to determine the recency period of the data that has to be considered.

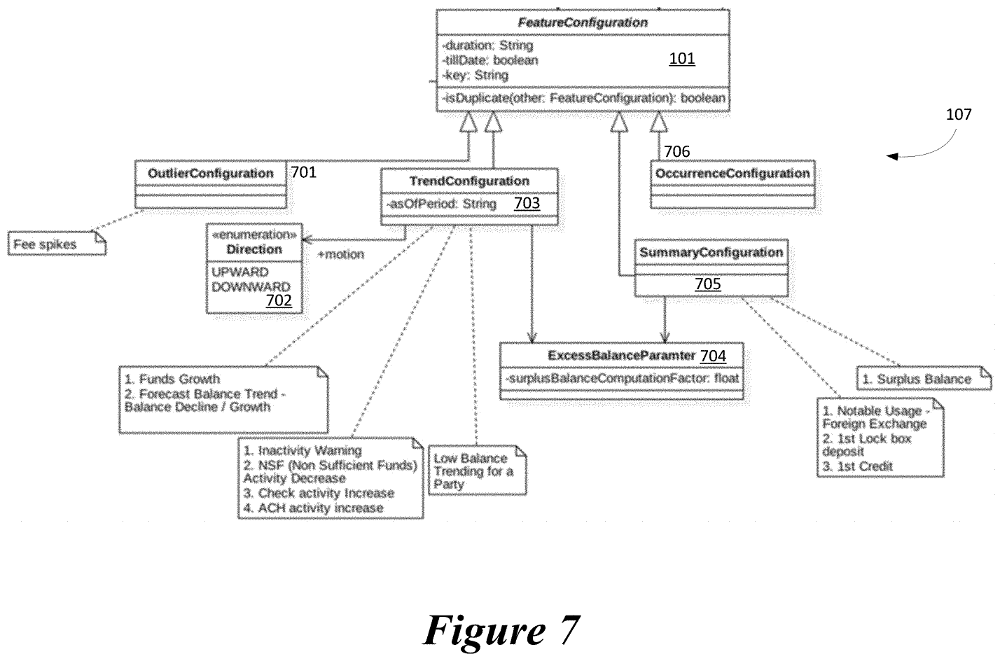

FIG. 7 is a detailed object diagram of the feature configuration. A feature configuration can be further classified as configuration of trend 703, configuration of aggregated summary 705, configuration of occurrence detection 706 and the configuration of an outlier detection 701 object.

The trend configuration 703 takes a parameter designating the period of the trend, as well as an enumeration of the direction 702 (upward or downward). The trend could be looking for the growth of funds, the forecasting of balances, and could monitor for a low balance trending toward insufficient funds. Other trends could include an inactivity warning or an increase in activity.

A summary configuration 705 may calculate the surplus balance or note the first foreign exchange transaction or the first lock box deposit or the first credit. The surplus balance could be used to calculate an excess balance parameter 704 that could be used in the summary configuration 705 or in a trend 703.

Each of the outlier configuration 701, the trend configuration 703, the summary configuration 705, and the occurrence configuration 706 inherit basic configuration information from the generic feature configuration 101.

With the configuration data from each of the trends 107, feature metric 102, data level 103, feature filter 104, and threshold 105 objects, the feature configuration 101 is configured.

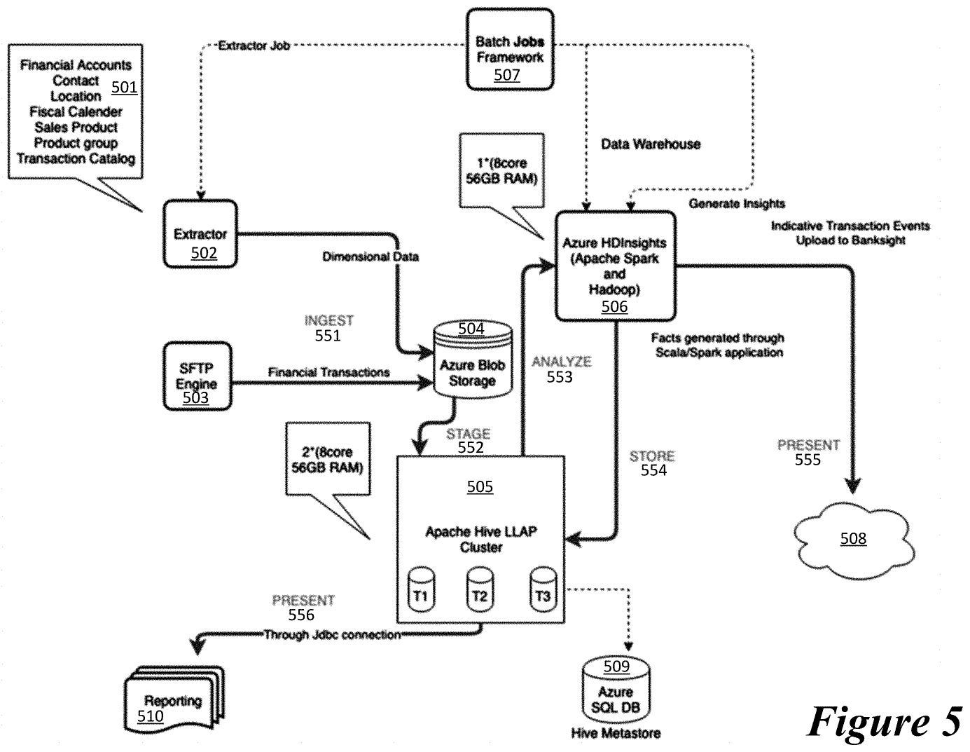

FIG. 5 is a diagram of the operating functions of the system as it gains insights from the inferred attributes. The operational aspects begin with the ingesting 551 of the data, then the data is staged 552, and analyzed 553. The analysis 553 is then stored 554 before being presented 555, 556 to the users.

The ingesting 551 function takes information 501 from financial accounts, contact information, location (from GPS, cell towers, etc.), fiscal calendars, sales information, transaction catalogs, product definitions and product groupings. Information could come from customer relationship management software, such as Salesforce.com, or from social media (LinkedIn, Facebook, Google+, for instance). Some information may come from a batch jobs framework 507 that triggers 502 to collect information from a data warehouse, and other core banking data sources. An extractor 502 extracts the information and stores the dimensional data in the Azure blob storage 504.

In addition, financial transactions are loaded into the Azure blob storage 504 from a secure file transfer protocol engine 503.

An Apache Hive LLAP (Low Latency Analytical Processing) daemon 505 operates in a processor cluster, pulling data from the Azure blob storage 504, and staging 552 the data. This cluster 505 is an 8 core, 56 GB RAM server, in one embodiment, and could have a database per tenant. A tenant is the owner of the data and usually it is the bank whose data is being processed. In some embodiments, T1, T2, and T3 are the 3 databases for 3 tenants. In some embodiments, this Apache Hive LLAP cluster 505 pulls the features metric 102 and the feature filters 104 from the configuration and stages the data through those filters. The Azure SQL or any other database 509 stores metadata about objects, such as the table definition (column names, data types, comments, etc.). This is a portion of the configuration information. The rest of the configuration could also be stored in the Azure SQL database 509.

The Apache Hive LLAP Cluster 505 also presents 556 the data through a Java database connectivity connection to a reporting 510 software module.

The data is then analyzed 553 with Azure HDInsights 506. This uses Apache Spark and Hadoop. The Azure HDInsights 506 could run on an 8 core, 56 GB RAM server. This server 506 processes the filtered data from the Apache Hive LLAP 505 server, and generates insights based on the threshold. These insights indicate the transaction events that the users has indicated are of interest based on the configuration. In some instances, these insights are presented 555 to the user through the internet 508 to the user's computer 601, 602. Other insights are stored 554 back in the Apache Hive LLAP cluster 505.

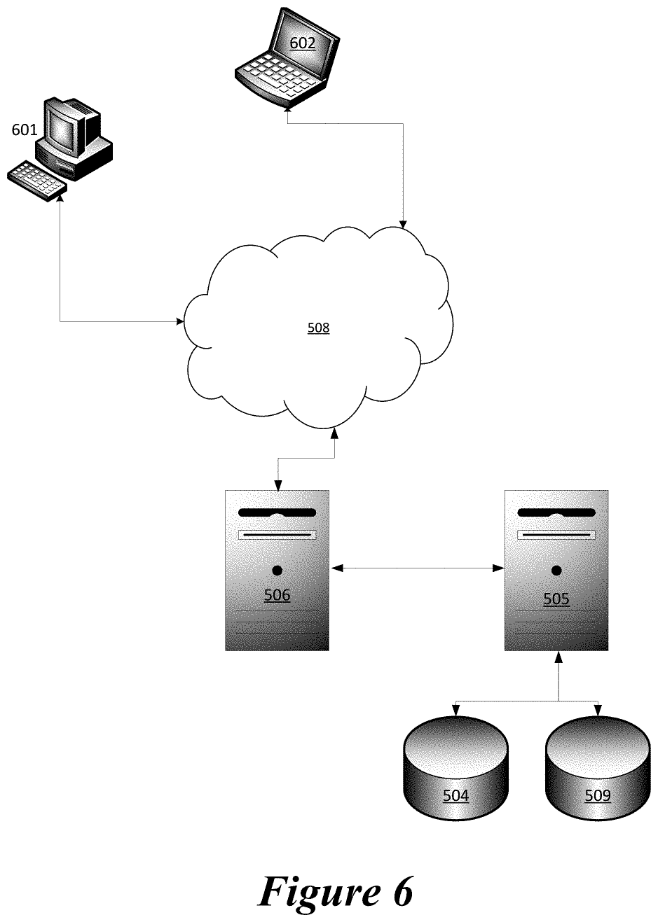

FIG. 6 shows a possible hardware embodiment for the inventions described above. A special purpose Apache Hive LLAP server 505 is used to run the Apache Hive LLAP cluster software to collect and filter the data (see FIG. 5). This special purpose Apache Hive LLAP server 505 is connected to the Azure blob database storage device 504 that holds the financial transactions and the dimensional data. The special purpose Apache Hive LLAP server 505 could also be connected to an Azure SQL database 509. The Azure SQL database 509 and the Azure blob database storage device 504 may include high speed, high capacity storage media such as a solid state drive or a high performance hard disk drive. The special purpose Apache Hive LLAP server 505 is designed to perform a large number of operations as required to collect and filter the data, and has many processing cores to handle to collect and filter the data in parallel. In some embodiments, the special purpose Apache Hive LLAP server 505 and the high capacity storage 504, 509 are a plurality of devices that operate in distributed locations across the Internet.

The Azure HDInsights server 506 is also a special purpose server designed to perform a large number of operations as required to analyze the insights and the data, and has many processing cores to handle to analysis of the data in parallel. The Azure HDInsights server 506 and the Apache Hive LLAP server 505 are connected together through a network connection, that could be through an internet or through local area network connection. In some embodiments, it could be connected through a bus structure, or through communications between processes on the same server (making the hardware distinction virtual).

Laptops 602 and/or personal computers 601 (and/or other computing devices such as mobile phones, smart watches, iPads, tablets, notebook computers, internet of things devices, etc.) connect through the internet 508 (through the cloud) to the special purpose Azure HDInsights server 506. These computing devices 601,602 typically serve as the user interface to the system. This is the device the user logs in on, and the device that displays the insights. The models of user behavior and the algorithm to create the insights could be run on the computing devices 601,602, or could be run on the special purpose Azure HDInsights server 506 (or on another computer on the network).

It should be appreciated that many of the elements discussed in this specification may be implemented in a hardware circuit(s), a circuitry executing software code or instructions which are encoded within computer readable media accessible to the circuitry, or a combination of a hardware circuit(s) and a circuitry or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a circuitry or control block executing code encoded in a computer readable media, or a combination of a hardware circuit(s) and a circuitry and/or control block executing such code.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the inventions have been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the inventions. In addition, while a particular feature of the inventions may have been described above with respect to only one or more of several illustrated embodiments, such feature may be combined with one or more other features of the other embodiments, as may be desired and advantageous for any given or particular application.

1. A system for creating insights about banking customer behavior, the system comprising:
an internet;
a special purpose data management server, in communication with a special purpose insights server, wherein the special purpose data management server ingests data related to financial transactions and dimensional data, as specified by an insight configuration, creates inferred attributes through automated statistical analysis of the data, and filters the inferred attributes to a subset of attributes needed to perform the insights according to the insight configuration;
a blob storage device connected to the special purpose data management server, the blob storage device storing the financial transactions and the dimensional data;
a SQL storage device connected to the special purpose data management server, the SQL storage device storing at least a portion of the configuration data;
the special purpose insights server in communication to the internet, wherein the special purpose insights server performs an insight analysis on the subset of the attributes received from the special purpose data management server, as specified by the insight configuration, over a period of time, and reporting the insights as found by the insight analysis to a computing device;
the computing device in communication to the special purpose insights server via the internet.

2. The system of claim 1 wherein the dimensional data is retrieved from social media.

3. The system of claim 1 wherein the dimensional data is retrieved from a customer relationship management system.

4. The system of claim 1 wherein the performance of the insight analysis returns a numerical score.

5. The system of claim 4 wherein the numerical score is weighted.

6. The system of claim 1 wherein the performance of the insight analysis is a calculation of a plurality of numerical scores.

7. The system of claim 1 wherein the insight analysis includes a trend over time.

8. The system of claim 7 wherein the trend is of a surplus balance.

9. The system of claim 1 wherein the performance of the insight analysis returns a Boolean result.

10. The system of claim 9 wherein the Boolean result is derived from a plurality of conditions.

11. A method for creating insights about banking customer behavior, the method comprising:
configuring the insight configuration about the banking customer;
ingesting data related to financial transactions and dimensional data, as specified by the insight configuration;
creating inferred attributes through automated statistical analysis of the data;
filtering the inferred attributes to a subset of attributes needed to perform the insights according to the insight configuration;
performing an insight analysis on the subset of the attributes as specified by the insight configuration, over a period of time, and
reporting the insights as found by the insight analysis.

12. The method of claim 11 wherein the dimensional data is retrieved from social media.

13. The method of claim 11 wherein the dimensional data is retrieved from a customer relationship management system.

14. The method of claim 11 wherein the performance of the insight analysis returns a numerical score.

15. The method of claim 14 wherein the numerical score is weighted.

16. The method of claim 11 wherein the performance of the insight analysis is a calculation of a plurality of numerical scores.

17. The method of claim 11 wherein the insight analysis includes a trend over time.

18. The method of claim 17 wherein the trend is of a surplus balance.

19. The method of claim 11 wherein the performance of the insight analysis returns a Boolean result.

20. The method of claim 19 wherein the Boolean result is derived from a plurality of conditions.
